(19) United States
(12) Patent Application Publication
(10) Pub. No.: US 2010/0253805 A1
(43) Pub. Date: Oct. 7, 2010

(54) IMAGE DATA MANAGEMENT APPARATUS

(75) Inventor: Tomonaga YASUDA, Tokyo (JP)

Correspondence Address: VOLPE AND KOENIG, P.C., UNITED PLAZA, 30 SOUTH 17TH STREET, PHILADELPHIA, PA, 19103, US

(73) Assignee: Olympus Corporation, Tokyo (JP)

(21) Appl. No.: 12/818,702

(22) Filed: Jun. 18, 2010

Related U.S. Application Data
(62) Division of application No. 11/184,378, filed on Jul. 19, 2005.

(30) Foreign Application Priority Data
Aug. 30, 2004 (JP) 2004-250275
Aug. 30, 2004 (JP) 2004-250276
Aug. 30, 2004 (JP) 2004-250277

(51) Int. Cl. H04N 5/76

(52) U.S. Cl. 348/231.2; 348/E07.001

(57) ABSTRACT

When a CPU obtains a directive about an attribute of an image data file stored on a memory card, it is determined whether or not the image data file has an attribute related to the directive. Then, an album list file containing album lists including file names having common attributes relating to the directive in the image data files stored in the memory card is generated.

### CROSS REFERENCE TO RELATED APPLICATIONS

This application is a divisional of U.S. patent application Ser. No. 11/184,378, filed on Jul. 19, 2005 which claims the benefit of Japanese Application Nos. 2004-250275, filed on Aug. 30, 2004, 2004-250276, filed on Aug. 30, 2004, and 2004-250277, filed on Aug. 30, 2004, the contents of which are incorporated herein by reference.

### BACKGROUND OF THE INVENTION

1. Field of the Invention

The present invention relates to data management technology, and more specifically to the technology of managing image data stored in a storage medium.

2. Description of the Related Art

Some image data management apparatuses including digital camera, etc. have an “album” facility. The album facility enables images represented by image data recorded on a storage medium to be compiled into one or more groups (albums) and each image contained in each album to be browsed, managed, etc. for each album.

An example of a method of managing image data for realizing the album function is explained below by referring to FIG. 1.

In FIG. 1, a memory card 200 which is a removable storage medium is inserted into a camera 100, and each type of data can be stored on the memory card 200. The memory card 200 stores an image root folder 300 and album list files 401-1, 401-2, . . . , 401-n, . . . .

The image root folder 300 is a root folder storing an image data file.

The image data representing an image is stored as image data files 311-1, 311-2, . . . , 311-n . . . (hereinafter referred to as a representative image data file 311) in an image storage folder (“100 OLYMP” folder) 310 in the image root folder 300 (“DCIM” folder). The image data file 311 stores attribute information indicating the attribute of the stored image data as, for example, the header information about image data. The attribute information can be, for example, shooting date information about an image represented by the image data, information indicating the size of the image, information indicating the quality (level of the compression of the data-compressed image data) of the image, identification information indicating whether the image is a static image or a moving picture, identification information about whether or not audio data is added to the image data file 311, identification information about whether or not erasing the image data file 311 is permitted (erase protection information), etc.

In FIG. 1, the characters “P001”, “P002”, and “Pxxx” described in the respective image data files 311 indicate the file names respectively assigned to the image data files 311, and the numeric portions of the file names show the shooting order of an image. Although not explicitly shown in FIG. 1, an extension is assigned to a file name. In the following explanation, the identification as to whether the image represented by the image data file 311 is a static image or a moving picture can be performed based on the extension. The album list files 401-1, 401-2, . . . , 401-n, . . . (hereinafter referred to as representative album list files 401) are control data file, and show the album lists 402-1, 402-2, . . . 402-n, . . . (hereinafter referred to as representative album lists 402) indicating the dependence between each of the image data files 311 and an album in which images represented by the image data files 311 are registered (an album to which the image data files 311 belong).

The album list 402 contains a file name of each image data file 311 as the information designating the image data file 311 about an image registered in the album. The order of arranging the file names in the album list 402 is used as the order information indicating the order of regenerating images registered in the album when they are regenerated and displayed.

The album name “ALBUMn” is added as identification information to each of the album list files 401, and the album name is associated with the album list 402. In the present embodiment, it is assumed that each album is assigned “ALBUM1”, “ALBUM2”, “ALBUM3”, etc. in the ascending order.

In FIG. 1, for easier explanation, it is assumed that the file name of a data file having different data contents does not coincide with another name in the image root folder 300. Therefore, the image data file 311 under the image root folder 300 can be uniquely designated only using the file name indicated in the album list 402. For example, if the information (file path name, etc.) about the storage position, etc. of the image data file 311 is indicated in the album list 402 in addition to the file name of the image data file 311, then the image data file 311 can be uniquely designated although the file names of the image data files 311 stored in the different image storage folders 310 under the image root folder 300 coincide with each other.

In the example shown in FIG. 1, the album function can be used by the camera 10 by managing the image data file 311 as described above.

As the technology similar to the above-mentioned image data management method, for example, Japanese Published Patent Application No. Hei 5-307593 discloses the technology of describing in the control file the related information about each image data such as a data format, a pixel size, a data compression system, etc. and a pointer indicating the leading storage position in each image information file of each image data and recording them in the recording medium, and referencing the pointer indicated in the control file when image data having the same related information is continuously regenerated and when the subsequent image data is regenerated in recording plural pieces of image data is recorded on a recording medium as an image information file obtained by combining the image data with the header information, thereby reading only image data without reading the header information from the image information file and quickly regenerating the data.

However, in many image regeneration devices which provide the above-mentioned album function, two operations, that is, the operation (all frame regenerating operation) of sequentially regenerating an image about all image data stored in the storage medium and the operation (album regenerating operation) of sequentially regenerating the image registered in a predetermined album, can be performed.

Many image data management apparatuses which provide the above-mentioned album function also provide the function of erasing a stored image. There are various types of erasing functions. For example, a one-frame erase function erases a frame of an image data file 14-n. An all frame erase function erases all frames of image data files 14-n stored on a memory card 11. In the image data management apparatus, a camera 10 specifically tends to continue shooting images even after consuming unused storage areas by shooting operations using the memory card 11. Therefore, the erase function is strongly required.

### SUMMARY OF THE INVENTION

The apparatus according to an aspect of the present invention regenerates image data and displays the data on the monitor screen, and includes: a setting unit for setting the apparatus in an album registration mode for registration of the image data in an album; a registration condition display unit for displaying a registration condition for collective registration of image data recorded on a recording medium on the monitor screen when the album registration mode is set; a registration condition selection unit for selecting a desired registration condition from an album list in which an album can be registered; an attribute extraction unit for extracting attribute information corresponding to the selected registration condition from the image data displayed on the monitor screen; and an album registration unit for selecting image data having the extracted attribute from the image data recorded on the storage medium, and collectively registering information for designation of the selected image in a predetermined album.

The apparatus according to another aspect of the present invention manages image data, and includes: an attribute directive obtaining unit for obtaining a directive about an attribute of an image data file; an attribute identification unit for identifying whether or not an image data file has an attribute relating to the directive; and a control data file generation unit for generating a control data file describing designation information designating an image data file sharing the attribute relating to the directive.

The apparatus according to a further aspect of the present invention references an album describing a list of image data registered based on a predetermined condition, regenerates image data based on the list, displays an image, and includes: a selection unit for selecting image data recorded on a recording medium; a recognition unit for determining whether or not the selected image data has been registered in an album, and recognizing an album to which the image data belongs when the album has been registered; a directive unit for issuing a directive to regenerate the album to which the image data belongs during the regeneration of the selected image data; and an album regeneration unit for regenerating image data currently being displayed based on the list of the album in which the image data is registered when the directive is issued and it is determined that the image data is registered in the album.

The apparatus according to a further aspect of the present invention regenerates an image, and includes an image regeneration unit for regenerating an image; a group regeneration directive obtaining unit for obtaining a directive to regenerate an image belonging to a group formed by a plurality of images; a group designation unit for designating a group to which an image being regenerated by the image regeneration unit belongs when the directive is obtained; and a group image regeneration unit for sequentially regenerating images belonging to the designated group.

The apparatus according to a further aspect of the present invention manages image data, and includes: a first erase directive obtaining unit for obtaining a first directive to erase storage of all image data files stored on a storage medium; a directive request unit for requesting a directive whether or not an image data file indicating the possibility of erasing an image belonging to one of the groups formed by a plurality of images in the image data files; a second erase directive obtaining unit for obtaining a second directive indicating the possibility of erasing an image data file showing an image belonging to any of the groups; and an erase unit for erasing all storage indicating images belonging to any of the groups in the storage of the image data file in the storage medium when the second directive obtained after obtaining the first directive permits erasing.

The apparatus according to a further aspect of the present invention regenerates and displays image data registered in an album based on a predetermined condition, and includes an all frame erase directive unit for directing all image data recorded on a recording medium to be erased; a recognition unit for recognizing whether or not all image data recorded on a recording medium has been registered in an album; and an erase unit for erasing both all image data registered in an album and a related album when an all frame erase directive is issued with the all image data recognized as registered in an album.

### BRIEF DESCRIPTION OF THE DRAWINGS

The present invention will be more apparent from the following detailed description when the accompanying drawings are referenced.

FIG. 1 shows an example of realizing an album function;

FIG. 2 shows the configuration of the camera embodying the present invention;

FIG. 3 is a rear elevation of the camera shown in FIG. 2;

FIG. 4A is a flowchart (1) showing the contents of the process of the first example of the image regenerating process;

FIG. 4B is a flowchart (2) showing the contents of the process of the first example of the image regenerating process;

FIG. 5A is a flowchart (1) of the contents of the collective date registration process;

FIG. 5B is a flowchart (2) of the contents of the collective date registration process;

FIG. 6A is a flowchart (1) of the contents of the collective moving picture registration process;

FIG. 6B is a flowchart (2) of the contents of the collective moving picture registration process;

FIG. 7A shows an example (1) of a display screen of a regenerated image;

FIG. 7B shows an example of a regeneration display screen accompanied by superposed display of an icon of an album name;

FIG. 7C shows the first example of a regenerating operation menu screen;

FIG. 7D shows an example of an album selection screen;

FIG. 7E shows an example of an attribute menu screen;

FIG. 7F shows an example of a display screen of calendar display;

FIG. 7G shows an example of a collective registration execution directive screen;

FIG. 8 is a block diagram of the function when the camera shown in FIG. 2 provides an album quick regeneration function;

FIG. 9A is a flowchart (1) of the contents of the second example of the image regenerating process;

FIG. 9B is a flowchart (2) of the contents of the second example of the image regenerating process;

FIG. 10A shows an example of a regeneration display screen accompanied by the superposing display of an album name icon and the superposing display of a frame number when an all frame regenerating operating is performed;

FIG. 10B shows the second example of a regenerating operation menu screen;

FIG. 10C shows an example of a regeneration display screen accompanied by the superposing display of an album name icon and the superposing display of a frame number when an album is quickly regenerated;

FIG. 10D shows the third example of a regenerating operation menu screen;

FIG. 11A is a flowchart (1) of the contents of the third example of the image regenerating process;

FIG. 11B is a flowchart (2) of the contents of the third example of the image regenerating process;

FIG. 12A shows an example (2) of a display screen of a regenerated image;

FIG. 12B shows the fourth example of a regenerating operation menu screen;

FIG. 12C shows an example of an erasing method menu screen;

FIG. 12D shows an example of a process performing screen;

FIG. 12E shows an example of an album registration image erase directive screen;

FIG. 12F shows an example of an all image erase completion report screen;

FIG. 12G shows an example of an image erase album selection directive screen;

FIG. 12H shows an example of a process performance directive screen;

FIG. 13 shows a first variation example of an image regenerating process shown in FIGS. 11A and 11B;

FIG. 14 shows a second variation example of an image regenerating process shown in FIGS. 11A and 11B; and

FIG. 15 shows an example of a standard configuration of a computer.

### DESCRIPTION OF THE PREFERRED EMBODIMENTS

The embodiments of the present invention are explained below by referring to the attached drawings. The following explanation relates to an embodiment of the present invention applied to a camera.

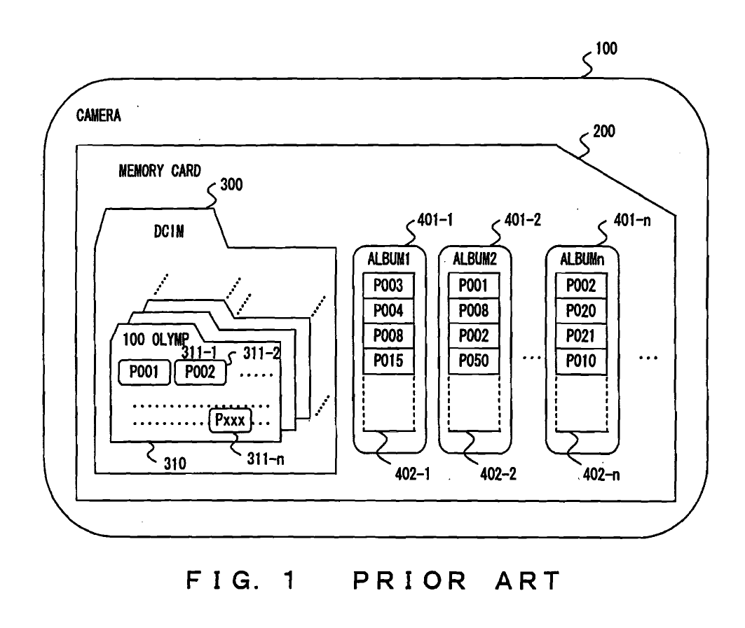

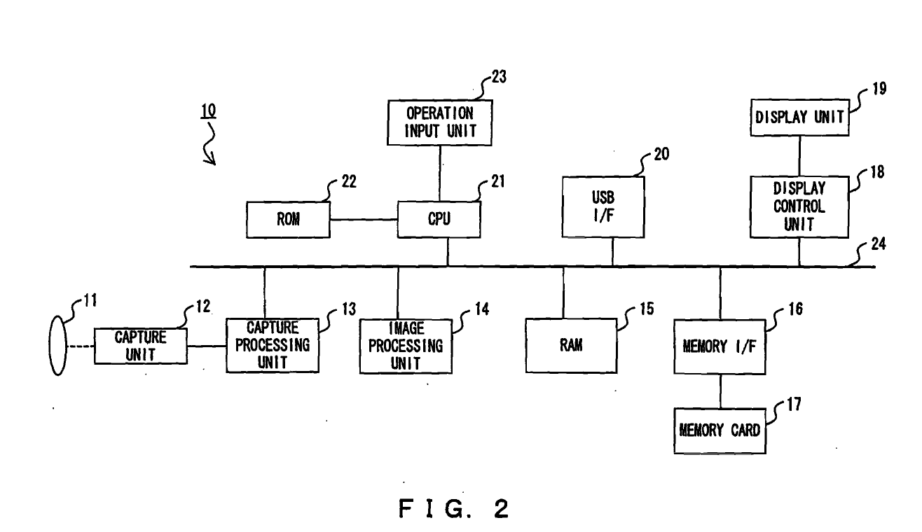

The explanation is first given by referring to FIG. 2. FIG. 2 shows the configuration of a camera 10 embodying the present invention. The camera 10 provides an album function explained by referring to FIG. 1.

In FIG. 2, a capture processing unit 13, an image processing unit 14, RAM 15, memory I/F 16, a display control unit 18, a USB I/F 20, and a CPU 21 are connected to a bus 24, and various data can be communicated under the control of the CPU 21.

A subject image formed by a lens 11 is converted to an electric signal by a capture unit 12 which is, for example, a CCD (charge coupled device) and input to the capture processing unit 13. The capture processing unit 13 performs an analog-to-digital conversion after amplifying an input electric signal to a predetermined size, and outputs image data indicating the image representing a subject image.

The image processing unit 14 performs image processing such as gamma correction, edge enhancement, white balance adjustment, etc. of image represented by the image data on the image data output from the capturing unit 13. When image data is recorded on a memory card 17, a data compressing process is performed as necessary on the image data. Furthermore, when an image represented by the image data recorded on the memory card 17 is regenerated and displayed, and a data decompressing process is performed as necessary on the image data read from the memory card 17.

The RAM 15 is random access memory used as a work area as necessary when the image processing unit 14 and the CPU 21 perform various processes.

The memory I/F (interface) 16 connects the memory card 17 to the bus 24, and enables various data to be read from the memory card 17 and written to it.

The memory card 17 is a storage medium removable from the camera 10. In the storage area, the CPU 21 manages image data as with the memory card 200 shown in FIG. 1. In the following explanation, the names and the reference numerals of data files and folders stored on the memory card 17 are those used in the explanation relating to FIG. 1.

The display processing unit 18 transmits image data received through the bus 24 to a display unit 19 after performing a digital-to-analog conversion.

The display unit 19 is, for example, an LCD (liquid crystal display), and displays an image represented by image data input to the display processing unit 18.

The USB (universal serial bus) I/F 20 is an interface for communication of various data by connecting the camera 10 to, for example, external equipment such as a personal computer (PC), etc.

The CPU (central processing unit) 21 performs an operation control on the entire camera 10.

ROM 22 is read only memory storing a control program executed by the CPU 21 and various data used as necessary when the control program is executed. The CPU 21 can perform the above-mentioned operation control by executing the control program.

Operation input units 23 are switches operated by a user of the camera 10, and obtains from a user and passes an instruction associated with the contents of an operation to the CPU 21.

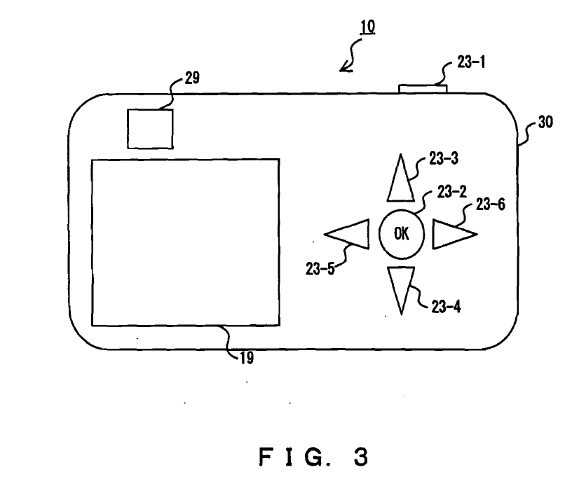

FIG. 3 is a rear elevation of the camera 10. In FIG. 3, a release button 23-1 for obtaining a shooting operation performing directive, a determination button 23-2 for obtaining an instruction to display a menu screen and an instruction to perform various operations, and cross buttons 23-3, 23-4, 23-5, and 23-6 for obtaining a direction directive, all of which are provided in a housing 30, are switches configuring the operation input unit 23.

FIG. 3 also shows that a finder 29 and the display unit 19 are provided at the rear of the housing 30.

Described below are various control programs executed by the CPU 21 relating to the present invention. Each of the control programs explained below is realized by the CPU 21 reading the control program stored in the ROM 22.

First explained below is the control process for realizing the collective registration function of registering a plurality of images in an album. The collective registration function refers to the camera 10 determining the attribute of an image (image data file 311) stored on the memory card 17, and collectively registering images having a common attribute in a single album (group). An attribute of an image can be, for example, a shooting date, the type of image, that is, a moving picture or a static image, an image size and quality (data compression rate), the presence/absence of added audio data, the presence/absence of settings of erase inhibit (what is called “protect”), etc.

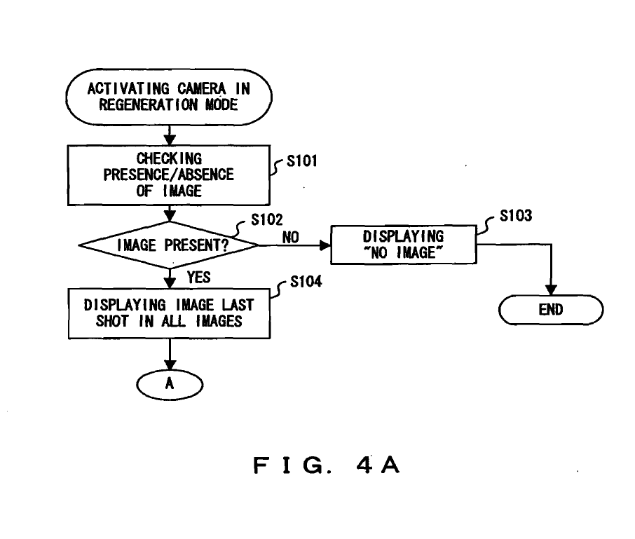

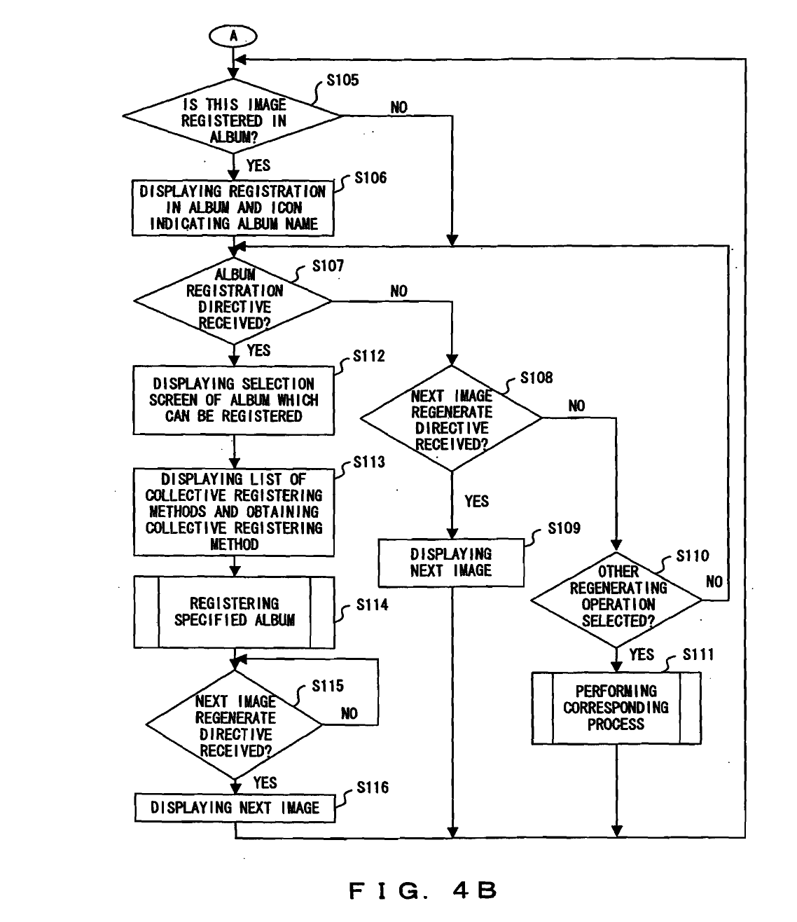

To allow the collective registration function to be provided by the camera 10, the CPU 21 is allowed to perform the control processes shown in the flowcharts in FIGS. 4A, 4B, 5A, 5B, 6A, and 6B.

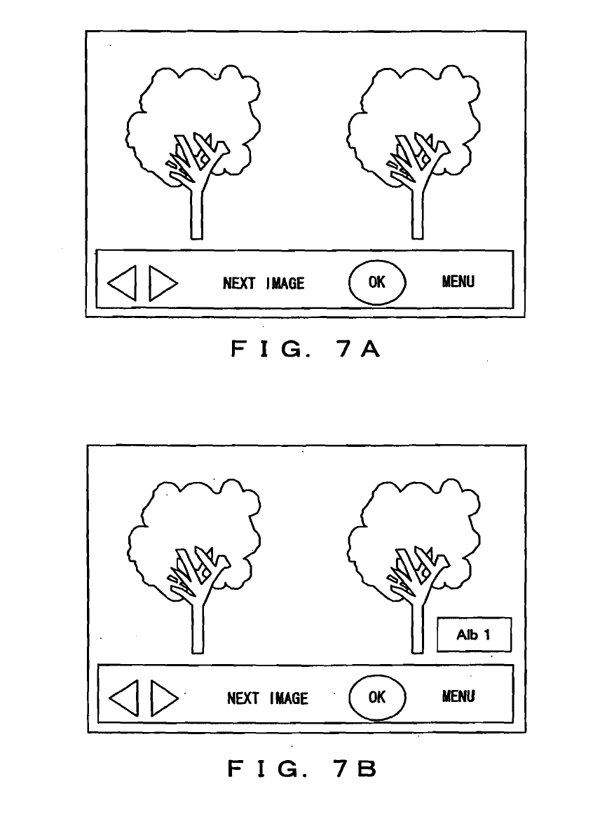

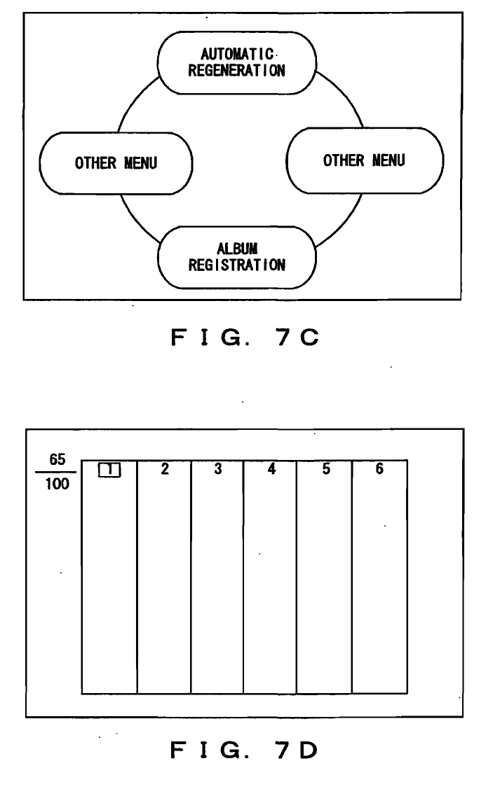

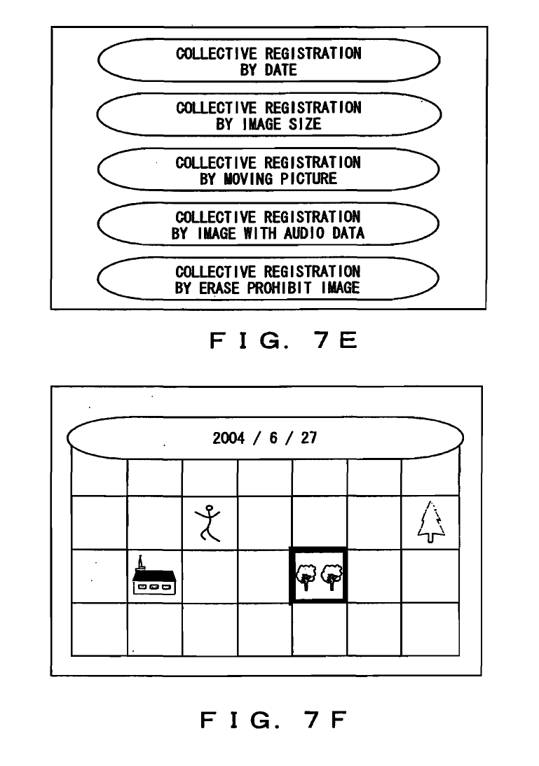

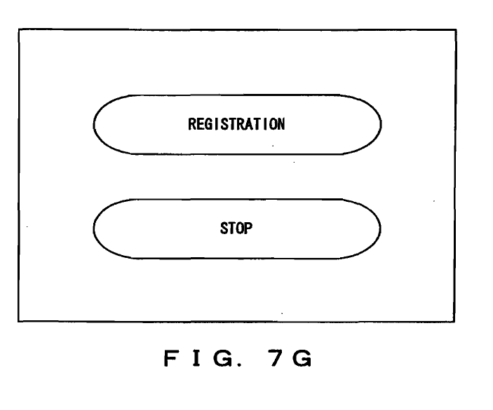

Each of the flowcharts is explained below by referring to FIGS. 7A, 7B, 7C, 7D, 7E, 7F, and 7G each of which shows an example of a display screen on the display unit 19.

First, the flowcharts in FIGS. 4A and 4B are explained below. These figures show the first example of the contents of the image regenerating process. This process is to regenerate an image stored on the memory card 17 by the display unit 19, and the camera 10 can provide the above-mentioned collective registration function by performing the process. This process is started when the camera 10 is activated under the settings (regeneration mode) of performing an image regenerating operation.

In S101 shown in FIG. 4A, the existence of an image is checked. In S102, a process of determining whether or not there is an image is performed. That is, a process of determines whether or not there is the image data file 311 in the image storage folder 310 storing the image data file 311 of the images shot by the camera 10. If there is the image (YES as a determination result), control is passed to S104. If there is no image (NO as a determination result), the indication that there is no image to be regenerated on the memory card 17 is displayed on the display unit 19 for a predetermined time in S103, the image regenerating process is terminated, and control is passed to the process of waiting for an instruction from a user.

In S104, in the image data file 311 stored in the image storage folder 310, an image last shot by the camera 10 is read and displayed on the display unit 19. FIG. 7A shows a screen sample displayed on the display unit 19 in this process. At the lower portion of the screen sample, an operation guide indicating the meaning of the operation of each of the switches of the operation input unit 23 is displayed.

Control is passed to FIG. 4B, and it is determined in S105 whether or not the image being displayed on the display unit 19 has already been registered in any album. That is, it is determined whether or not the file name of the image data file 311 about an image is arranged in any of the album lists 402 of the album list file 401 stored on the memory card 17. Only if the image has already been registered in any of the albums (YES as a determination result), the process in S106, that is, the process of displaying that the image currently being displayed has been registered in an album, and displaying the icon indicating the album name of the album in which the image has been registered is performed.

In S106, to be more concrete, the CPU 21 refers to the album list file 401 storing the album list 402 listing the file name of the image data file 311, and displays the icon corresponding to the album name listed in the file.

FIG. 7B shows an example of displaying an icon as superposed and displayed. In the example shown in FIG. 7B, an icon with the characters “Alb 1” indicating that the image being displayed has been registered in the album having the album name “ALBUM 1” is displayed. That is, by displaying the icon, a user is informed that there is the album list file 401 having the album list 402 containing the file name of the image data file 311 about the image being displayed on the display unit 19, and that the file name is listed in the album list 402 of the album list file 401 about the album having the file name “ALBUM1”.

In S107, an operation directive by a user to the operation input unit 23 is obtained, and it is determined whether or not the contents of the directive refer to an album registration directive. If it is determined that an album registration directive has been obtained (YES as a determination result), control is passed to S112. If it is determined that an album registration directive has not been obtained (NO as a determination result), then control is passed to S108.

An album registration directive is issued, for example, as follows. That is, when FIG. 7A or FIG. 7B is displayed, a user presses the determination button 23-2 according to the operation guide. When the CPU 21 recognizes the press of the button, it displays a regenerating operation menu screen as shown in FIG. 7C on the display unit 19. Then, the user selects the “album registration” operation on the menu screen by pressing the cross buttons 23-3, 23-4, 23-5, and 23-6, and the determination button 23-2. The album registration directive is issued by the above-mentioned selecting operation.

In S108, a user obtains an operation directive to the operation input unit 23, and it is determined whether or not the contents of the directive refers to a directive to display the next image by switching the image currently being displayed and regenerated. If it is determined that a directive to display the next image has been obtained (YES as a determination result) in S109, the next image in order preceded by the image currently being displayed is displayed on the display unit 19. Afterwards, control is returned to S105, and the above-mentioned processes are repeated.

A “next image display” directive is issued by, for example, a user operating the cross buttons 23-3, 23-4, 23-5, and 23-6 when FIG. 7A or FIG. 7B is displayed.

In S108, if it is determined that a directive to display the next image has not been obtained (NO as a determination result), then, in S110, a user operation directive to the operation input unit 23 is obtained and it is determined whether or not the contents of the directive refer to a directive to perform other processes. If it is determined that such directive has been obtained (YES as a determination result), the process corresponding to the directive is performed in S111. Afterwards, control is returned to S105, and the above-mentioned processes are repeated. If it is determined that such a directive has not been obtained (NO as a determination result), control is returned to S107, and the process of obtaining a user operation directive to the operation input unit 23 is repeated.

The instruction to perform other processes is issued by, for example, a user operating the operation input unit 23 and selecting an operation other than “album registration” on the menu screen when the regenerating operation menu screen shown in FIG. 7C is displayed. An explanation of the contents of the process performed when the instruction is obtained is omitted here.

In the above-mentioned process in S107, when it is determined that an album registration directive has been obtained, a screen for selection of an album by a user in which an image is to be registered from a list of albums in which images can be registered is displayed on the display unit 19, and the process of obtaining a directive to select an album from a user is performed in S112. FIG. 7D shows a screen example.

FIG. 7D shows the numbers from 1 to 6 assigned to each of the rectangles like spines of books (albums). The display indicates that there are six albums from “ALBUM 1” to “ALBUM 6” as a candidate to be selected as an album in which an image is to be registered. In FIG. 7D, the number “1” is displayed as enclosed by a rectangle. This indicates that the “ALBUM 1” is selected as an album in which the image is to be registered. Furthermore, the numbers “65/100” shown at the leftmost of the figure indicate that the “ALBUM 1” currently being selected can include up to “100” images, and 65 images have been registered up to now.

The candidate for an album to be selected as a destination in which an image is to be registered can be switched by a user operating the cross buttons 23-3, 23-4, 23-5, and 23-6. When the user pressed the determination button 23-2, the album selected at this time is determined as an album in which the image it to be registered, and the CPU 21 obtains the album according to the album selection directive by the user.

In S113, the display unit 19 displays a screen (attribute menu screen) for allowing a user to select an instruction about an attribute common among target images (image data file) to be registered in an album, and an attribute instruction of a user is obtained. FIG. 7E shows the screen example.

The attribute menu screen shown in FIG. 7E shows the options such as “collective registration by date” for collective registration of images having the same shooting date in the same album as an attribute common among target images to be registered in the album, “collective registration by image size” for collective registration of images of the same image size in the same album, “collective registration by moving picture” for collective registration of moving pictures in the same album, “collective registration by image with audio data” for collective registration of images in the image data file 311 assigned audio data, and “collective registration by erase prohibited image” for collective registration of images in the image data file 311 for which erase prohibited settings are made.

When a user operates the operation input unit 23 and selects one of the options on the menu screen, the CPU 21 obtains the option as an attribute directive from a user.

The execution order can be inverted between the above-mentioned processes S112 and S113 by first obtaining the attribute directive and then obtaining an album designation directive for designation of an album for collective registration of images.

In S114, the above-mentioned collective registration process is performed on the album depending on the attribute obtained in the process in S113. The details of the process are described later.

In S115, the process in S108, that is, the process of obtaining an operation directive by a user to the operation input unit 23, and determining whether or not the contents of the directive refer to a directive to display the next image by switching the image currently being displayed and regenerated. If it is determined that an instruction to display the next image has been obtained (YES as a determination result), then the next image in order preceded by the currently displayed image is displayed on the display unit 19 in S116, then control is returned to S105, and the above-mentioned processes are repeated. On the other hand, if it is determined that the instruction to display the next image has not been obtained (NO as a determination result), the process in S115 is repeated.

The process up to this point is the image regenerating process.

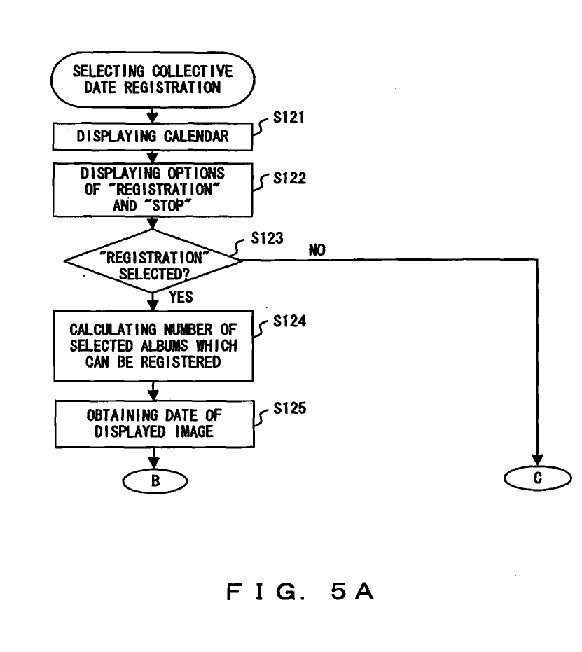

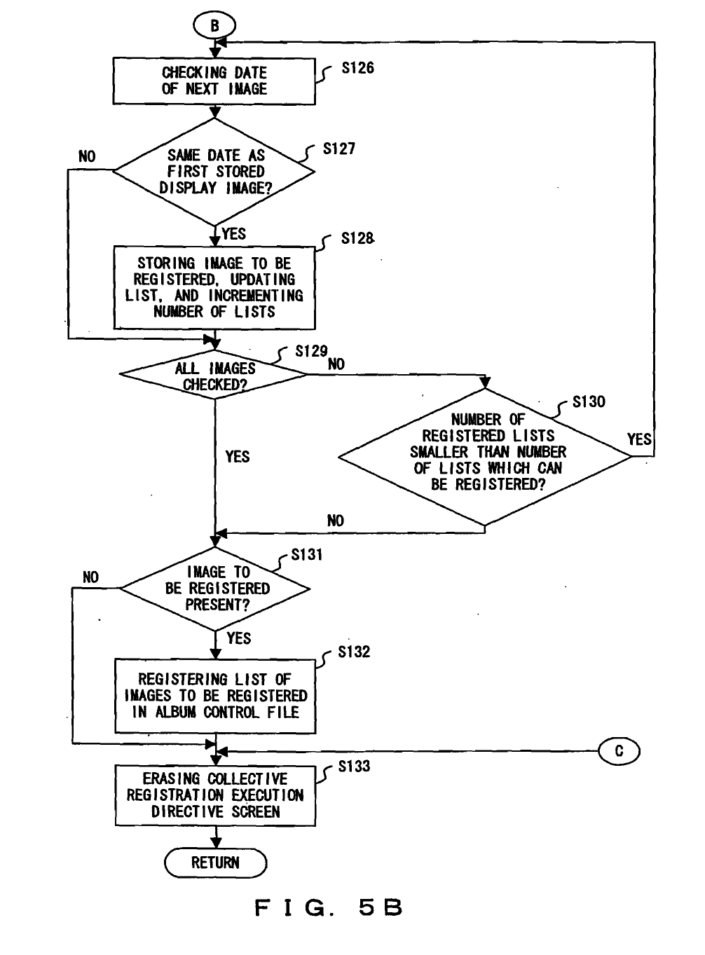

Explained below are FIGS. 5A and 5B. The flowcharts shown in these figures show the contents of the collective date registration process. The process is performed as the process in S114 when, in the process in S113 in the above-mentioned image regenerating process, the attribute of the same shooting date as the image being displayed is directed by a user as an attribute common among target images to be registered in an album (when “collective registration by date” is selected from among the options shown in the screen example shown in FIG. 7E).

In FIG. 5A, first in S121, a calendar display is displayed on the display unit 19.

FIG. 7F shows a display screen example of calendar display. On the screen shown in FIG. 7F, a list of images shot on the same shooting date as the image shown in FIG. 7A or FIG. 7B is displayed, above the list, the date of the shooting date is displayed as the display for allowing a user to recognize the attribute common among the images. In the list of the images, the image displayed on the display unit 19 just before the album designation screen is displayed is enclosed by a bold frame.

When the process in S121 shown in FIG. 5A is started, the CPU 21 references the shooting date information in the attribute information indicated in the image data file 311 stored on the memory card 17. From the information, the data indicating the same shooting date as the shooting date indicated by the shooting date information in the attribute information in the image data file 311 of the images displayed on the display unit 19 is extracted. Then, a list of the extracted images of the image data file 311 is displayed on the display unit 19 together with the date of the shooting date, and the image is enclosed by a bold frame, thereby displaying the screen shown in FIG. 7F.

In S122, the screen on which an instruction to perform a process of collectively regenerating the image having the same shooting date as the image being displayed in the same album, or an instruction to stop performing the process is requested is displayed on the display unit 19.

FIG. 7G shows a screen example of the screen (collective registration execution directive screen). When the above-mentioned calendar display screen is displayed and the pressing operation on the determination button 23-2 of the operation input unit 23 is detected, the CPU 21 displays the screen on the display unit 19. The user further operates the operation input unit 23, and “registration” or “stop” is selected.

In S123, it is determined whether or not the selection of the user is “registration”. If “registration” is selected (YES as a determination result), control is passed to S124. If “stop” is selected (NO as a determination result), control is passed to S133 shown in FIG. 5B.

In S124, the number “n” of the images which can be registered in the album in which images are to be registered and which is obtained in the above-mentioned process in S112 (FIG. 4B) is calculated.

In the present embodiment, the total number of images to be registered in an album is predetermined (for example, 100 images per album). Therefore, in the process in S124, the remaining number of image to be registered can be calculated by subtracting the number of images currently registered in the album in which images are to be registered from the total number of images to be registered.

In S125, the shooting date of the image being displayed, that is, the date of the shooting date indicated by the shooting date information in the attribute information of the image data file 311 of the image is obtained.

In S126 shown in FIG. 5B, one of the image data files 311 stored on the memory card 17 is referenced. In the subsequent S127, it is determined whether or not the image data file 311 being referenced has an attribute of the same image shooting date as the image data file 311 of the image being displayed, that is, whether or not the shooting date information indicated by the attribute information about the image data file 311 being displayed shows the same shooting date as the day obtained in the process in S125. Only when the shooting date is the same (YES as determination result), the file name of the image data file 311 being referenced is stored in a predetermined storage area of the RAM 15 in S128. Furthermore, the value of the variable “m” calculated as the number of images to be registered in an album in which images are to be registered in an album in the collective date registration process is incremented by 1.

In S129, it is determined whether or not a shooting date has been checked in the processes in S126 and S127 on all of the image data files 311 stored on the memory card 17. If it is completed (YES as a determination result), control is passed to S131. If there is any file not checked yet (NO as a determination result), control is passed to S130.

In S130, it is determined whether or not the number of images to be registered in an album in which images are to be registered in the collective date registration process is smaller than the number of images which can be currently registered in the album in which image are to be registered, and further collective registration can be performed, that is, whether or not the above-mentioned value of “m” is smaller than the above-mentioned value of “n”. If it is determined that further collective registration can be performed (YES as a determination result), control is returned to S126, and the above-mentioned process is repeated. If it is determined that further collective registration cannot be performed (NO as a determination result), control is passed to S131.

In S131, it is determined whether or not there is an image to be registered in an album in the collective date registration process, that is, whether or not there is a file name stored in the RAM 15 by performing the above-mentioned process in S128. Only when there is an image to be registered in an album (YES as a determination result), the album list 402 shown in the album list file 401 about the album in which images are to be registered is referenced, and the file name stored in the RAM 15 is sequentially added to the end of the list, thus updating the album list 402, and the album list file 401 in which the album name which is the identification information about the album is associated with the album list 402 is generated in S132.

In S133, The collective registration execution directive screen (screen illustrated in FIG. 7G) displayed on the display unit 19 in the above-mentioned process in S122 is erased, and the display is returned to the display screen (screen illustrated in FIG. 7A or FIG. F7B) of the shot image displayed on the display unit 19 before performing the process in S112 shown in FIG. 4B. Afterwards, the collective date registration process terminates, and control is returned to FIG. 4B.

When displayed shot images are collectively registered in the above-mentioned process, the display screen of the shot images is changed from the screen shown in FIG. 7A to the screen with an icon as shown in FIG. 7B.

The above-mentioned process is the collective date registration process. In the process, when a collective date registration directive is received from a user, the shooting date of the image displayed on the display unit 19 is detected by the CPU 21, and the images having the same shooting date are collectively registered in the same album, thereby simply arranging the image data. In addition, the operation of the camera 10 is not required to specify the shooting date of the images to be collectively registered.

In the process in S113 of the above-mentioned image regenerating process, when a user specifies an attribute of the same size of image as an attribute common among the target images to be registered in an album (when “collective registration by image size” is selected from among the options shown in the screen example shown in FIG. 7E), the process performed as the process in S114 is basically the same as the collective date registration process shown in FIGS. 5A and 5B. However, in S121 shown in FIG. 5A, a list of images of the same size is displayed, and the targets in S125 shown in FIG. 5A and S126 and S127 shown in FIG. 5B are the image size information in the attribute information about the image data file 311.

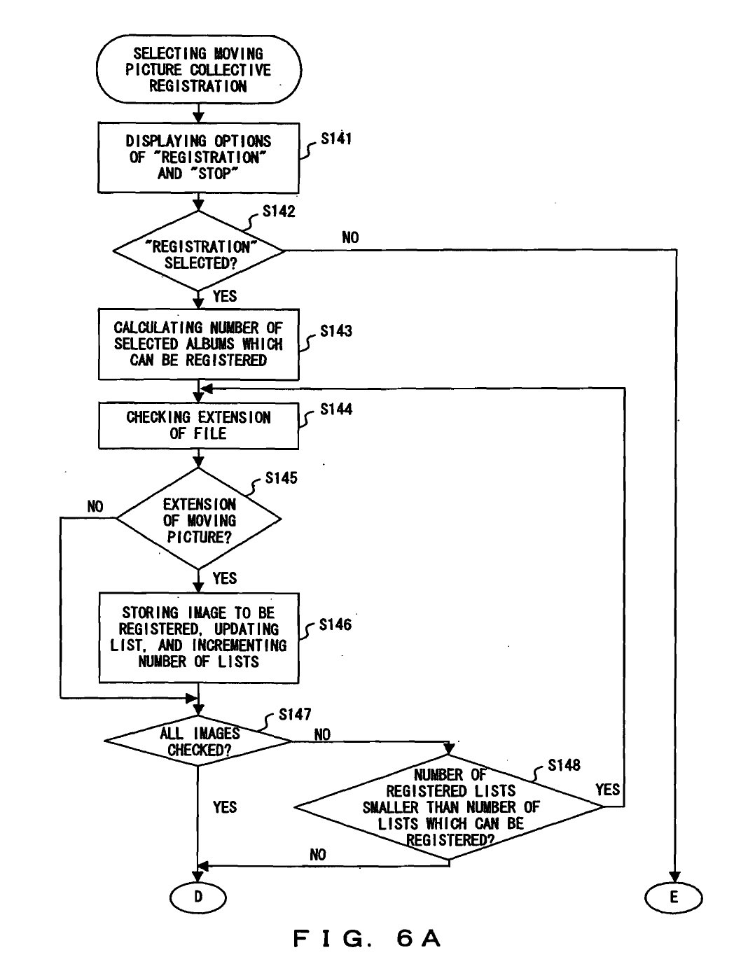

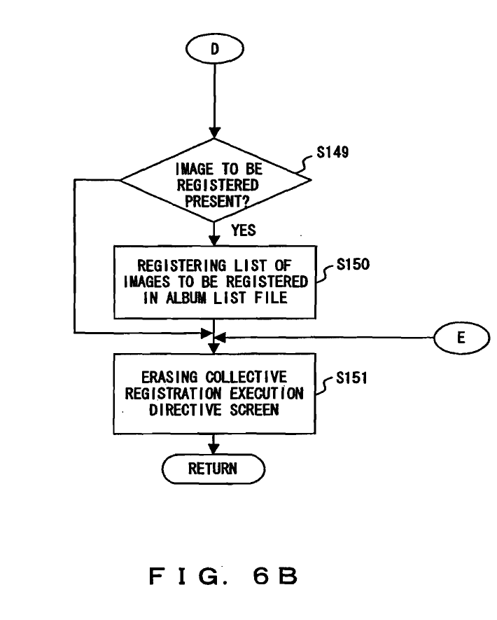

Explained below are FIGS. 6A and 6B. The flowcharts shown in these figures show the contents of the collective moving picture registration process. This process is performed as the process in S114 when an attribute of a moving picture is indicated by a user (when “collective registration by moving picture” is selected from among the options shown in the screen example shown in FIG. 7E) as an attribute common among the target images to be registered in an album in the process of the above-mentioned image regenerating process in S113 (FIG. 4B).

In FIG. 6A, first in S141, the screen on which an instruction to perform the process of collectively register moving pictures in the same album on an instruction to stop the performance of the process is requested is displayed on the display unit 19.

For this screen (collective registration execution directive screen), for example, the screen shown in FIG. 7E can be used. The user operates the operation input unit 23 to select “registration” or “stop”.

In S142, it is determined whether or not the selection by the user is “registration”. If “registration” has been selected (YES as a determination result), control is passed to S143. If “stop” is selected (NO as a determination result), control is passed to S151 shown in FIG. 6B.

In S143, the number “n” of the images which can be registered in an album in which images are to be registered and which is obtained in the process in S112 (FIG. 4B) is calculated. The process is the same as the process in S124 (FIG. 5A) in the above-mentioned collective date registration process.

In S144, one of the image data files 311 stored on the memory card 17 is referenced. Then, in S145, it is determined whether or not the image data file 311 being referenced contains moving pictures, to be more concrete, whether or not the extension of the image data file 311 being referenced refers to a moving picture file. Only when it refers to moving pictures (YES as a determination result), the file name of the image data file 311 being referenced is stored in a predetermined storage area of the RAM 15 in S146. Furthermore, the value of the variable “m” for the count of the number of images to be registered in an album in which images are to be registered is incremented (increased by 1) in this collective moving picture registration process.

The determination as to whether or not images are moving pictures can be performed according to the identification information indicated in the attribute information about the image data file 311, not based on the extension of the image data file 311.

In S147, it is determined on the entire image data files 311 stored on the memory card 17 whether or not it has been checked whether or not moving pictures are contained in the above-mentioned processes in S144 and S145. If the check has been completely performed (YES as a determination result), control is passed to S149 shown in FIG. 6B. If there is any file not checked yet (NO as a determination result), control is passed to S148.

In S148, it is determined whether or not the number of images to be registered in an album in which images are to be registered in this collective moving picture registration process is smaller than the number of images which can be currently registered in the album in which images are to be registered, and it is further determined whether or not further collective registration can be performed, that is, whether or not the above-mentioned value “m” is smaller than the value “n”. If it is determined that further collective registration can be performed (YES as a determination result), control is passed to S144, and the above-mentioned processes are repeated. On the other hand, if it is determined that further collective registration cannot be performed (NO as a determination result), control is passed to S149 shown in FIG. 6B.

Now, control is passed to FIG. 6B, and it is determined in S149 whether or not there is an image to be registered in an album in this collective moving picture registration process, that is, whether or not there is a file name stored in the RAM 15 by performing the above-mentioned process in S146 shown in FIG. 6A. Only when there is an image to be registered in an album (YES as a determination result), the album list 402 shown in the album list file 401 about the album in which images are to be registered is referenced, and the file name stored in the RAM 15 is sequentially added to the end of the list, thereby updating the album list 402, and generating the album list file 401 in which the album name which is the identification information about the album is associated with the album list 402 in S150.

In S151, the collective registration execution directive screen (screen illustrated in FIG. 7G) displayed on the display unit 19 in the above-mentioned process in S141 is erased, and the display is returned to the display screen (screen illustrated in FIG. 7A or 7B) of the shot image displayed on the display unit 19 before performing the process in S112 shown in FIG. 4B. Afterwards, this collective moving picture registration process is terminated, thereby returning control to FIG. 4B.

In the process in S113 (FIG. 4B) in the above-mentioned image regenerating process, when an attribute of an image with audio data is specified by a user (“collective registration by image with audio data” is selected from among the options shown in the screen example shown in FIG. 7E) as an attribute common among the target images to be registered in an album, and when an attribute of an erase prohibited image is specified by a user in the process performed as the process in S114 and the process in S113 (when “collective registration by erase prohibit image” is selected from among the options illustrated in FIG. 7E), the process performed as the process in S114 has the same contents as the collective moving picture registration process shown in FIGS. 6A and 6B. However, the check target in S144 and S145 shown in FIG. 6A is the information with audio data in the attribute information in the image data file 311 or the erase protection information as to whether it refers to erase protect or permit.

By performing the above-mentioned various processed by the CPU 21, the collective registration function in an album of a plurality of images can be provided by the camera 10.

In the above-mentioned embodiment, an image common in one of the attributes of the image data file 311 is collectively registered in the same album, but images common about two attributes can also collectively registered in the same album.

For example, to collectively register images which are moving pictures and for which erase protect settings are performed can be collectively register in the same album, for example, the process shown in FIGS. 4A and 4B can be performed by the CPU 21. However, when an instruction about the attribute of the image data file 311 in the process in S113 shown in FIG. 4B is obtained, the CPU 21 obtains a selection result of the two options of “collective registration by moving pictures” and “collective registration by erase prohibit image” as an instruction of an attribute on the menu screen illustrated in FIG. 7E, and performs the processes in FIG. 6A and FIG. 6B in the process sown in S114 shown in FIG. 4B. When the processes in FIGS. 6A and 6B are performed, in S144 and S145 shown in FIG. 6A, the extension (for identification of a moving picture) of the image data file 311 and the erase protect information about erase prohibit or permit in the attribute information about the image data file 311 are to be checked. The filenames of the images common between them are listed in the album list 402 in the process in S150 shown in FIG. 6B.

Thus, the images having two common attributes in various attributes of the image data file 311, can be collectively registered in the same album, thereby easily generating an album classified into specific groups.

In a similar method, images having three or more common attributes can be collectively registered in the same album.

Described below is the function of regenerating an image registered in an album in the above-mentioned method, etc.

The regeneration function explained below is to start an album regenerating operation (operation of sequentially regenerating and displaying images registered in the album) about an album in which an image regenerated displayed on the display unit 19 when the instruction is received is registered when a predetermined instruction is received from a user during the operation of sequentially regenerating images about all image data stored on a storage medium (all frame regenerating operation) on the display unit 19.

For example, when the collective registration in an album of images for each shooting date is performed using the above-mentioned collective registration function, the regenerating function is convenient when a user suddenly hits upon browsing the image having the same shooting date as the image being displayed.

In the explanation below, the regeneration function is referred to as “album quick regeneration function”.

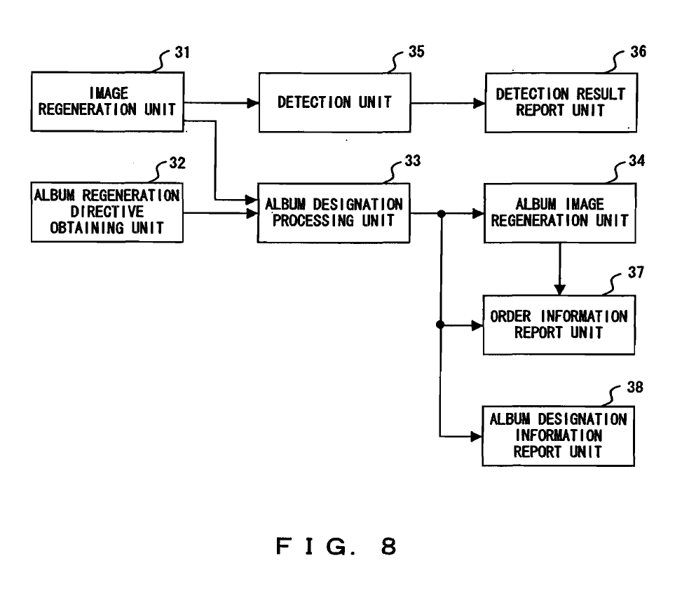

First, FIG. 8 is explained below. FIG. 8 is a block diagram of the function when the camera 10 shown in FIG. 2 provides an album quick regeneration function.

An image regeneration unit 31 regenerates and displays an image displayed in the image data file 311 stored on the memory card 17, and the display unit 19 in the camera 10 corresponds to the image regeneration unit 31.

An album regeneration directive obtaining unit 32 obtains an instruction to regenerate an image registered in an album.

An album designation processing unit 33 performs a process of designating an album in which an image regenerated by the image regeneration unit 31 is registered (of designating the album list 402 describing the file name of the image data file 311 about the image from the album list 402 of each of the album list file 401 stored on the memory card 17) when the album registration directive obtaining unit 32 obtains the above-mentioned instruction.

An album image regeneration unit 34 sequentially regenerates and displays an image registered in an album designated by the album designation processing unit 33.

A detection unit 35 detects whether or not an image being regenerated by the image regeneration unit 31 is registered in any album (whether or not there is the album list 402 describing the file name of the image data file 311 about the image is in any of the album list filed 401).

A detection result report unit 36 reports the detection result of the detection unit 35 to a user.

An order information report unit 37 reports the information indicating the order of registering the image to an album in which the image being regenerated by the album image regeneration unit 34 is registered.

A group designation information report unit 38 reports to a user the album name of the album in which the image being regenerated by the album image regeneration unit 34.

Explained below is the control process performed by the CPU 21 to structure the above-mentioned function block.

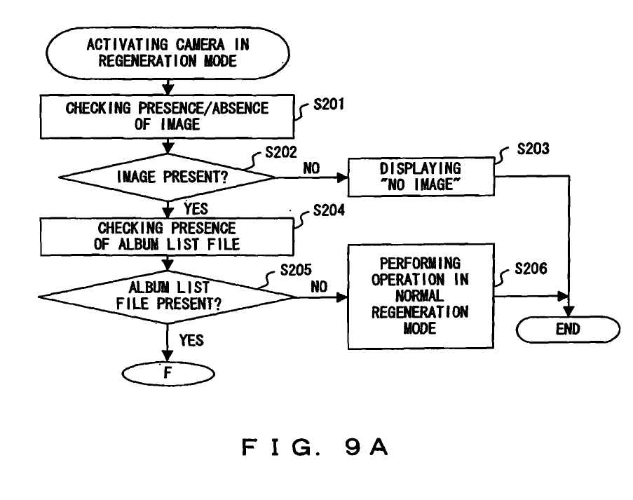

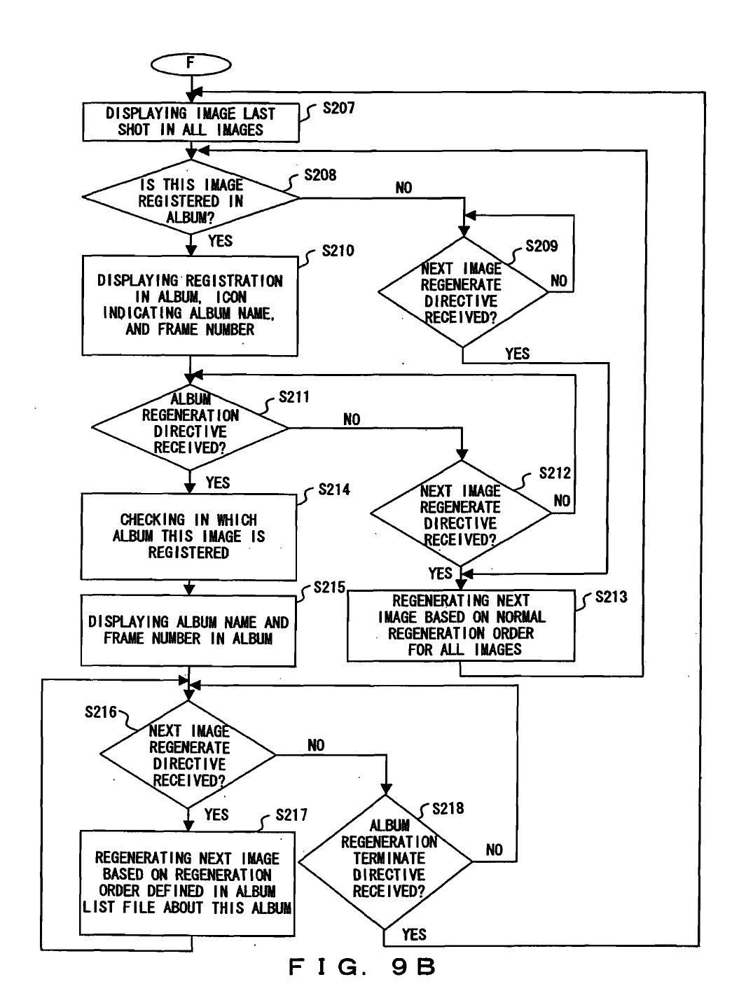

FIGS. 9A and 9B are flowcharts of the contents of the second example of the image regenerating process. By the CPU 21 performing the process shown in FIGS. 9A and 9B, the above-mentioned all frame regenerating operation is performed by the camera 10, and the above-mentioned album quick regeneration function is provided by the camera 10.

The processes shown in FIGS. 9A and 9B are explained below by referring to FIGS. 10A, 10B, 10C, and 10D showing the display screen examples on the display unit 19. The process is started when the camera 10 is activated under the settings (regeneration mode) for performing the image regenerating operation.

First, in S201 shown in FIG. 9A, it is checked whether or not there is an image. Then, in S202, the determining process as to whether or not there is an image is performed. That is, it is determined whether or not there is the image data file 311 in the image storage folder 310 storing the image data file 311 of images shot by the camera 10. If there is an image (YES as a determination result), control is passed to S204. If there is no image (NO as a determination result), the indication that there is no images to be regenerated on the memory card 17 is displayed on the display unit 19 for a predetermined time in S203, and then the image regenerating process is terminated and control is passed to the process of waiting for an instruction from a user.

In S204, it is checked whether or not there is the album list file 401. In S205, the determining process as to whether or not there is the album list file 401 is performed. That is, it is determined whether or not the album list file 401 is stored on the memory card 17. If there is the album list file 401 (YES as a determination result), control is passed to S207 shown in FIG. 9B. If there is no images (NO as a determination result), a normal regenerating operation process, for example, the image regenerating process shown in FIGS. 4A and 4B is performed in S206, thereby terminating the process in FIGS. 9A and 9B.

Control is passed to the process shown in FIG. 9B, and the image last shot by the camera 10 in the image data file 311 stored in the image storage folder 310 is read, and the image is displayed on the display unit 19 in S207. In this process, the screen example displayed on the display unit 19 is the same as that shown in FIG. 7A.

In S208, it is determined whether or not the image currently being displayed on the display unit 19 has already been registered in any album. That is, it is determined whether or not the file name of the image data file 311 of the image is included in any of the album lists 402 of the album list file 401 stored on the memory card 17. If the image has already been registered in any of the albums (YES as a determination result), then control is passed to S210. If the image has not been registered in any album (NO as a determination result), control is passed to S209. The CPU 21 which performs the process in S208 corresponds to the detection unit 35 shown in FIG. 8.

In S209, an operation directive by a user to the operation input unit 23 is obtained, and it is determined whether or not the directive refers to displaying the next image by switching the image currently being displayed and regenerated. If it is determined that a directive to display the next image has been obtained (YES as a determination result), then control is passed to S213. On the other hand, if it is determined (NO as a determination result) that the directive has not been obtained, the process in S209 is repeated until it is determined that the directive has been obtained.

In S210, the information that the image currently being displayed has been registered in an album, and the icon indicating the album name of the album in which the image is registered, and the frame number is displayed on the display unit 19.

In S210, to be more concrete, the CPU 21 references the album list file 401 storing the album list 402 containing the file names of the image data file 311 of the image being displayed, and the icon corresponding to the album name contained in the file is displayed on the display unit 19, and the numbers indicating the ordinal number of the frame of the shot image in the images stored on the memory card 17 after being shot by the camera 10 are displayed as a frame number on the display unit 19.

FIG. 10A shows an example of displaying an image with the icon and the frame number displayed as superposed on the image. In the example shown in FIG. 10A, as in the screen example shown in FIG. 7A, the operation guide indicating the meaning of the operation for each switch of the operation input unit 23 is displayed at the lower portion of the screen example. Furthermore, as in the screen example shown in FIG. 7B, the icon with characters “Alb 1” indicating that the image being displayed is registered in the album having the album name “ALBUM 1” is displayed as superposed on the right portion of the image. By displaying the icon, a user can be informed that there is the album list file 401 in the album list 402 containing the file name of the image data file 311 of the image being displayed on the display unit 19, and furthermore that the file name is included in the album list 402 of the album list file 401 of the album identified by “ALBUM 1”. That is, the display unit 19 displaying the icon corresponds to the detection result report unit 36 shown in FIG. 8.

In FIG. 10A, the characters “10” displayed as superposed on the left portion of the image display the frame number. By the display, the information that the image being displayed is the tenth shot image shot by the camera 10 and stored on the memory card 17 is announced to the user.

In S211, it is determined whether or not an operation directive by a user to the operation input unit 23 is obtained, and it is determined whether or not the contents of the directive refer to regenerating an album. If it is determined that an album registration directive has been obtained (YES as a determination result), control is passed to S214. If it is determined that an image regeneration device has not been obtained yet (NO as a determination result), then control is passed to S212.

An album registration directive is issued as follows. That is, a user presses the determination button 23-2 according to the above-mentioned operation guide. After recognizing the press of the button, the CPU 21 allows the regenerating operation menu screen as illustrated in FIG. 10B to be displayed on the display unit 19. The user selects “registration of the album” on the menu screen by pressing the cross buttons 23-3, 23-4, 23-5, and 23-6, and the determination button 23-2. By the selecting operation, an album registration directive is issued. Therefore, in this case, the operation input unit 23 corresponds to the album regeneration directive obtaining unit 32 in FIG. 8.

In S212, an operation directive by a user to the operation input unit 23 is obtained, and it is determined whether or not the contents of the directive refer to a directive to display and regenerate the next image by switching the image currently being displayed and regenerated. If it is determined that a directive to display the next image has been obtained (YES as a determination result), control is passed to S213. On the other hand, if it is determined that a directive to display and regenerate the next image has not been obtained (NO as a determination result), then control is returned to S211, and the process of obtaining an operation directive by a user to the operation input unit 23 is repeated.

In S213, the next image after the image being displayed is displayed on the display unit 19. Afterwards, control is returned to S208, and the above-mentioned process is repeated.

The directive to “display the next image” is issued by, for example, operating the cross buttons 23-3, 23-4, 23-5, and 23-6 when FIG. 10A is displayed.

On the other hand, when it is determined in the process in S211 that an album registration directive has been obtained, the album quick regenerating process from S214 to S218 as explained below is started. When the album quick regeneration is started, the image being displayed immediately before the album registration directive is received in S211, that is, the image regenerated and displayed in the one-frame regenerating operation, is displayed on the display unit 19, and the album registered images are sequentially regenerated and displayed from the image.

In S214, it is checked in which album the image currently being displayed on the display unit 19 has been already registered. That is, the album list file 401 which is stored on the memory card 17 and includes the album list 402 containing the file name of the image data file 311 of the image is checked. The CPU 21 which performs the process corresponds to the album designation processing unit 33 shown in FIG. 8.

In S215, the icon indicating the album name of the album in which the image currently being displayed is registered and the frame number of the image in the album are displayed on the display unit 19.

In S215, to be more concrete, the CPU 21 references the album list file 401 detected in the process in S214, the icon corresponding to the album name displayed in the file is displayed on the display unit 19, and the order of the file name of the image data file 311 of the image currently being displayed is counted in the album list 402 of the album list file 401, and the numbers indicating the count result is displayed as a frame number on the display unit 19.

FIG. 10C shows an example of image display in which the icon and the frame number are displayed as superposed on the image. In the example shown in FIG. 10C, as in the screen example shown in FIG. 7A, the operation guide indicating the meaning of the operation for each switch of the operation input unit 23 at this time is displayed at the lower portion of the screen example, and the icon of the number “1” reporting to the user that the image being displayed has been registered in the album having the album name “ALBUM 1” is displayed as superposed on the upper left portion of the image. The display unit 19 displaying the icon corresponds to the album designation information report unit 38 shown in FIG. 8.

In FIG. 10C, the character “3” displayed as superposed at the lower left portion of the image indicates the frame number. By the display of the frame number, the user is informed that the image being displayed has been registered as the third frame of the image in the album “ALBUM 1”. The display unit 19 displaying the frame number corresponds to the order information report unit 37 shown in FIG. 8.

In S216, an operation directive by a user to the operation input unit 23 is obtained, and it is determined whether or not the contents of the directive refer to the directive to switch the image currently being displayed and display and regenerate the next image in order in the album in which the image is registered. If it is determined that a directive to display the next image has been obtained (YES as a determination result), then control is passed to S217. If it is determined that a directive to display and regenerate the next image has not been obtained (NO as a determination result), then control is passed to S218.

In S217, the next image in order after the image currently being displayed in the album detected in the process in S214 is displayed on the display unit 19, and then, control is returned to S216, and the above-mentioned processes are repeated.

The directive to “display the next image” is issued by a user operating the cross buttons 23-3, 23-4, 23-5, and 23-6 when the display shown in FIG. 10C is performed.

In S218, an operation directive by a user to the operation input unit 23 is obtained, and it is determined whether or not the contents of the directive refer to a directive to terminate the album regeneration. If it is determined that an album regeneration terminate directive has been obtained (YES as a determination result), control is returned to S207, and the process for all frame regenerating operation is newly started. On the other hand, if it is determined that an album regeneration terminate directive has not been obtained (NO as a determination result), then control is returned to S216, and the process after obtaining the operation directive by a user to the operation input unit 23 is repeated. By repeating the process, the sequential regeneration and display of the image registered in the album are performed on the display unit 19, and the album image regeneration unit 34 shown in FIG. 8 is configured.

The album regeneration terminate directive is issued, for example, as follows. That is, when the display shown in FIG. 10C is performed, a user presses the determination button 23-2. When the CPU 21 recognizes the press of the button, the regenerating operation menu screen as illustrated in FIG. 10D is displayed on the display unit 19. The user presses the cross buttons 23-3, 23-4, 23-5, and 23-6 and the determination button 23-2, thereby selecting “returning to normal regeneration” on the menu screen. By the selecting operation, the album regeneration terminate directive is issued.

The processes described above refer to the second example of image regenerating process. When the processes are performed by the CPU 21, the above-mentioned album quick regeneration function can be provided by the camera 10.

Explained below is the storage erase function of the image data file 311 stored on the memory card 17. With the erase function explained below, when a directive to erase all image data files 311 stored on the memory card 17 is obtained, the images registered in any album in the image data files 311 are to be erased only when a directive to permit the erase of the images is received although a directive to erase “all” image data files 311 is received. On the other hand, when a directive to prohibit erasing the image data file 311 of the images registered in an album is received, only the images not yet registered in an album are erased in the image data files 311 stored on the memory card 17.

It is normally considered that the images registered in an album are possibly to be stored in the images stored on the memory card 17. Therefore, using the erase function, only the images not to be stored (that is, only the image data file 311 of the images not registered in an album) can be first collectively erased. Therefore, it is not necessary to perform a troublesome operation of issuing a directive to erase an image by determining frame by frame the necessity of storage of an image, thereby facilitating the entire operation. On the other hand, when it becomes less necessary to store an image registered in al album using the erase function, the image data file 311 of the images registered in al album can be collectively erased using the erase function. Therefore, for example, although images are to be continuously shot even after all storage areas on the memory card 17 are used after a shooting operation, the necessary storage area can be quickly reserved.

Described below is the control process performed by the CPU 21 to provide the storage erase function of the image data file 311 using the camera 10.

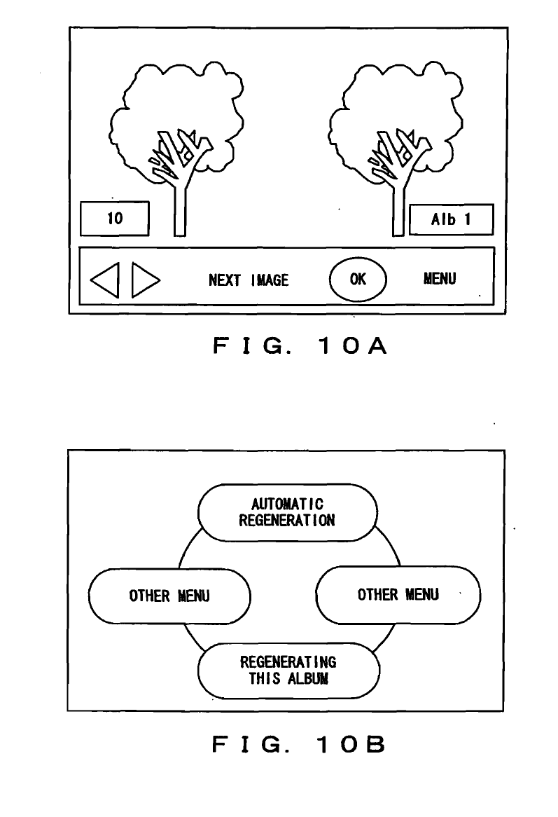

FIGS. 11A and 11B are flowcharts of the contents of the third example of the image regenerating process. The process shown in FIGS. 11A and 11B is performed by the CPU 21 to provide the above-mentioned storage erase function using the camera 10.

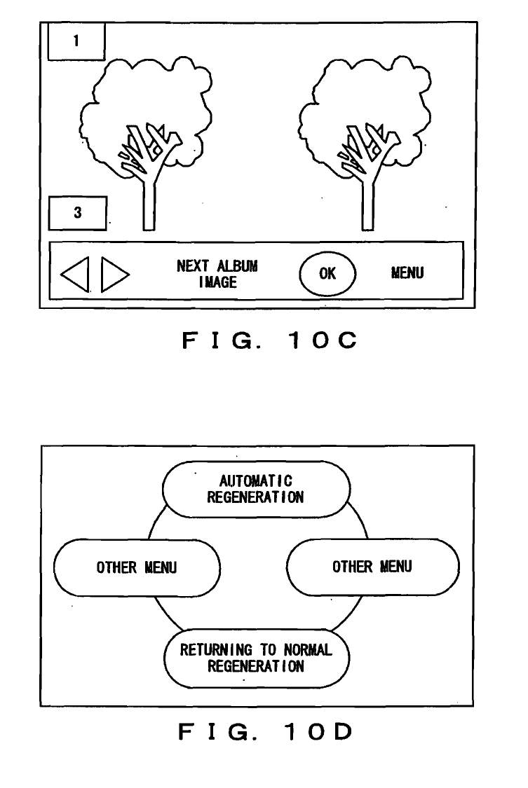

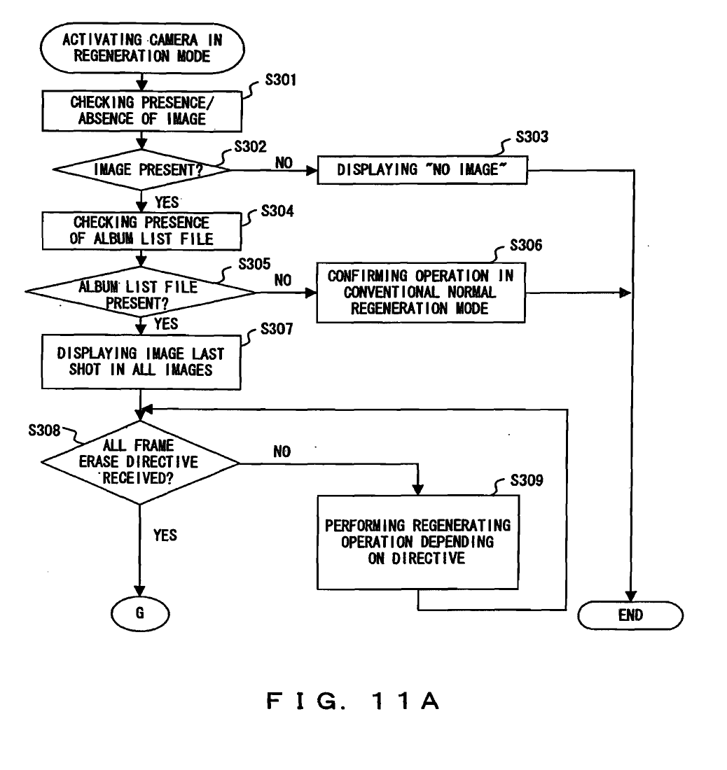

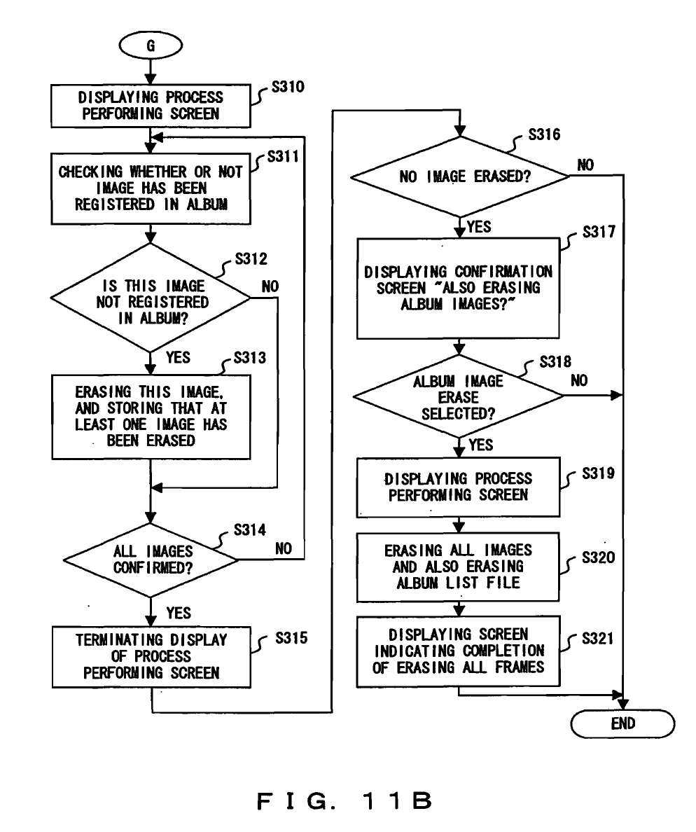

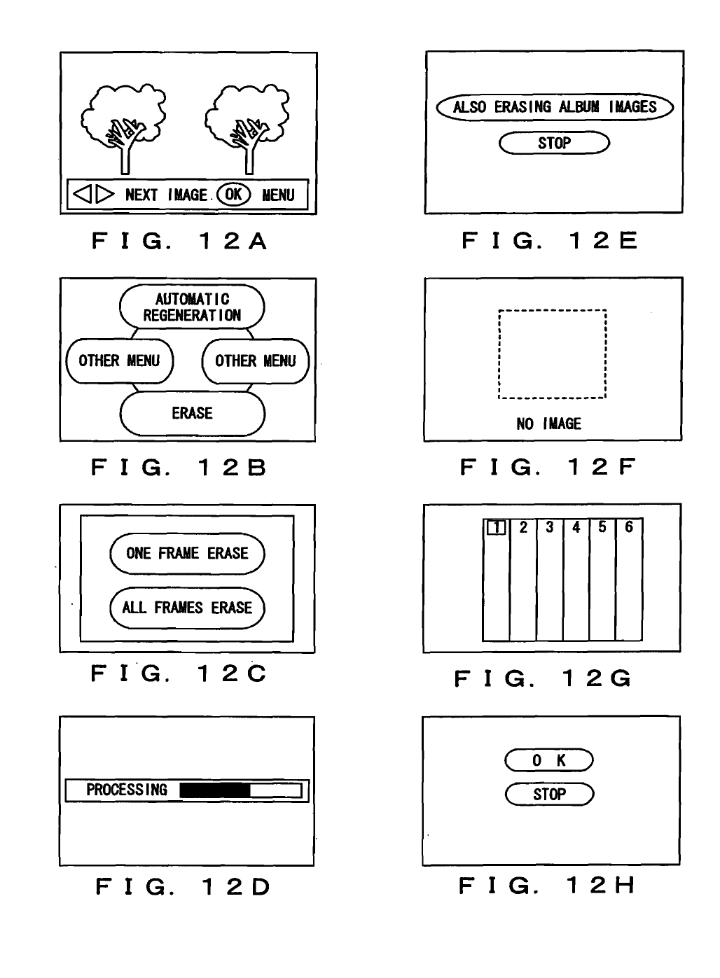

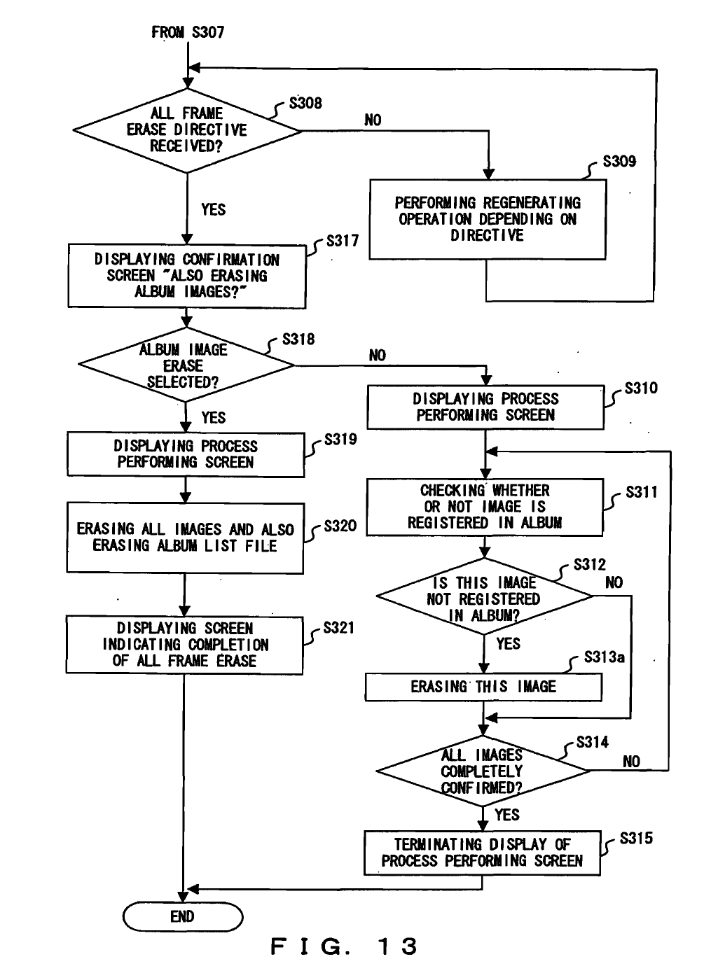

The process shown in FIGS. 11A and 11B is explained below by referring to FIGS. 12A, 12B, 12C, 12D, 12E, 12F, 12G, and 12H showing the display screen example on the display unit 19. The process is started when the camera 10 is activated under the settings (regeneration mode) for performing the image regenerating operation.

Since the processes from S301 to S307 shown in FIG. 11A are the same as those in S201 to S207 in the second example of the image regenerating process shown in FIGS. 9A and 9B, the explanation is omitted here. The display of the display unit 19 at the time when the process in S307 is completed is shown in FIG. 12A, and is similar to the display shown in FIG. 7A.

In S308, the operation directive by a user to the operation input unit 23 is obtained, and it is determined whether or not the contents refer to erasing all frames, that is, erasing all images stored on the memory card 17 (erasing storage of image data file). If it is determined that an all frame erase directive has been obtained (YES as a determination result), control is passed to S310 shown in FIG. 11B. If it is determined that the all frame erase directive has not been obtained (NO as a determination result), then control is passed to S309, a regenerating operation depending on the obtained directive is performed, control is returned to S308, and a user operation directive is obtained again.

For example, an all frame erase directive is issued as follows. That is, when the display shown in FIG. 12A is performed, a user presses the determination button 23-2 according to the above-mentioned operation guide. When the CPU 21 recognizes the press of the button, the regenerating operation menu screen as illustrated in FIG. 12B is displayed on the display unit 19. The user presses the cross buttons 23-3, 23-4, 23-5, and 23-6 and the determination button 23-2 to select “erase” on the menu screen. When the CPU 21 recognizes the selection result, the erasing method menu screen as illustrated in FIG. 12C is displayed on the display unit 19. Then, the user presses the cross buttons 23-3, 23-4, 23-5, and 23-6 and the determination button 23-2 again to select “all frames erase” on the menu screen. By the selecting operation, an all frame erase directive is issued.

Control is passed to FIG. 11B, and the process performing screen showing that a predetermined process is being performed as illustrated in FIG. 12D is displayed on the display unit 19 in S310.

In S311, one of the image data files 311 stored on the memory card 17 is referenced, and it is checked whether or not the image in the image data file 311 being referenced has been registered in any album, that is, whether or not the file name of the image data file 311 being referenced is contained in the album list 402 of the album list file 401 stored on the memory card 17.

In S312, it is determined whether or not the image has not been registered in any album. If the image has not been registered in any album (YES as a determination result), then the storage of the image data file 311 being referenced is erased from the memory card 17, and a flag (set to OFF as an initial value) indicating that the image data file 311 of at least one frame has been erased in this all frame erase defined in a predetermined storage area of the RAM 15 is turned ON in S313. On the other hand, in the process in S312, if it is determined that the image has been registered in any album (NO as a determination result), control is passed to S 314 without performing the process in S313.

In S314, it is determined on all image data files 311 stored on the memory card 17 whether or not it is confirmed that the image has not been registered in any album (that is, the determining process in S312). If the above-mentioned check has been performed on all image data files 311 stored on the memory card 17 (YES as a determination result), control is passed to S315. If there are still unchecked image data files 311 (NO as a determination result), control is returned to S311, and the process from S311 to S313 is repeated on the unchecked image data files 311.

In S315, the display of the process performing screen on the display unit 19 in the process in S310 is terminated.

In S316, it is determined whether or not the storage of the image data file 311 has not been erased after repeating the process from S311 to S313, that is, whether or not there are no images registered in any album in the images stored on the memory card 17. This process is performed by determining whether or not the above-mentioned flag which is defined in a predetermined storage area in the RAM 15 is set to ON.

In the determining process in S316, if the storage of the image data file 311 has never been erased (YES as a determination result), control is passed to S317. If the storage of the image data file 311 of at least one frame of image has been performed (NO as a determination result), then the process in FIGS. 11A and 11B is terminated.

If the result of the determining process in S316 is YES, the CPU 21 recognizes that all images (image data file 311) stored on the memory card 17 are stored in any album.

In S317, the screen on which a directive to erase the image registered in any album or not (whether or not the storage of the image data file 311 remaining on the memory card 17 is to be erased) is requested is displayed. FIG. 12E shows a screen example of the request screen.

In S318, an operation directive by a user to the operation input unit 23 is obtained after the process in S308, and it is determined whether or not the contents of the directive refer to erasing an image registered in any album, that is, whether or not the contents of the directive refer to erasing the image data file 311 whose file name is contained in the album list 402 of the album list file 401 stored on the memory card 17. If it is determined that the erase directive has been obtained (YES as a determination result), control is passed to S319. If it is determined that the erase directive has not been obtained (NO as a determination result), the process in FIGS. 11A and 11B terminates as is.

For example, the erase directive to erase an image registered in any album is performed as follows. That is, when album registration image collective erase directive screen as illustrated in FIG. 12E in the process in S317 is displayed on the display unit 19, the user presses the cross buttons 23-3, 23-4, 23-5, and 23-6 and the determination button 23-2 to select “erasing also album images” on the menu screen. By the selecting operation, all frame erase directive is issued.

In S319, the process performing screen illustrated in FIG. 12D indicating that a predetermined process is being performed is displayed on the display unit 19.

In S320, the image data files 311 remaining on the memory card 17, that is, all the image data files 311 registered in any album are erased, and all album list files 401 stored on the memory card 17 are erased.

In S321, the screen as illustrated in FIG. 12F showing that all image data files 311 stored on the memory card 17 including the images registered in an album have been completely erased is displayed on the display unit 19 for a predetermined time, and then the process shown in FIGS. 11A and 11B terminates.

Described above is the third example of the image regenerating process, and the process is performed by the CPU 21, thereby enabling the above-mentioned storage erase function of the image data file 311 to be used on the camera 10. When all image data files 311 stored on the memory card 17 are unnecessary and there are still images registered in albums, the process of erasing the image data files 311 can be easily performed.

In the process shown in FIGS. 11A and 11B, only one of the storage in the image data file 311 of images not registered in an album and the storage of the image data file 311 of images registered in an album can be collectively erased. Especially when the image data file 311 of the images not registered in an album is not stored on the memory card 17, the storage of the image data file 311 of the images registered in an album is collectively erased. Instead, when the image data file 311 of the images not registered in an album is stored on the memory card 17, and after the storage of the image data file 311 is erased, the storage of the image data file 311 of the images registered in an album can be collectively erased. To attain this, as shown in FIG. 11B, the process in S316 performed after the process in S315 is deleted, and the process after S317 can be performed after the process in S315.

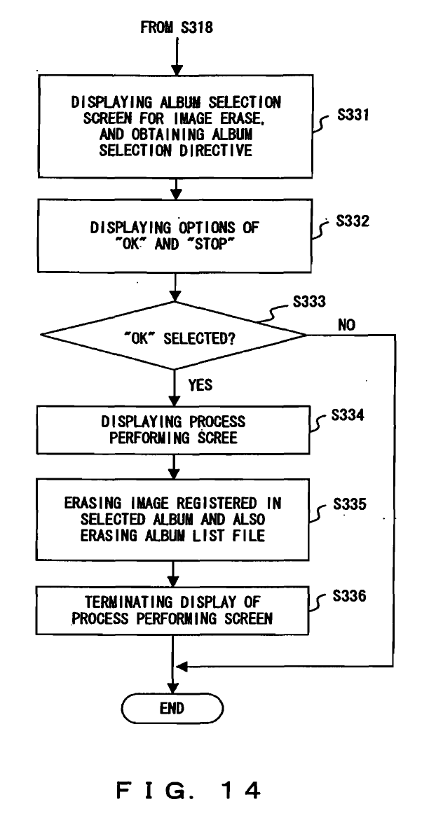

When the storage of the image data file 311 of the images not registered in an album and the storage of the image data file 311 of the images registered in an album can be collectively erased, an all frame erase directive to erase the first storage and a second storage erase directive, which is a directive to erase an image registered in an album, are first obtained, and the storage of all image data files 311 on the memory card 17 can be collectively erased according to both directives. To attain this, the order of the flow of the processes shown in the flowcharts in FIGS. 11A and 11B can be changed as shown in FIG. 13.

In the flowchart shown in FIG. 13, the same process steps as those shown in FIG. 11A or FIG. 11B are assigned the same reference numerals.

FIG. 13 is briefly explained below.

In S308 after the process in S307 shown in FIG. 11A, an operation directive by a user to the operation input unit 23 is obtained, and it is determined whether or not the contents of the directive refer to all frame erase, that is, erasing all images stored on the memory card 17 (erasing the storage of image data files). If it is determined that an all frame erase directive has been obtained (YES as a determination result), control is passed to S317. If it is determined that an all frame erase directive has not been obtained (NO as a determination result), then control is passed to S309, a regenerating operation is performed according to the obtained directive. Then, control is returned to S308, and an operation directive of a user is obtained again.

In S317, the screen as shown in FIG. 12E requesting a user to issue a directive to or not to erase an image registered in any album (whether or not the storage of the image data file 311 still remaining on the memory card 17) is displayed on the display unit 19.

In S318, an operation directive by a user to the operation input unit 23 is obtained after the process in S308, and it is determined whether or not the contents of the directive refer to erasing an image registered in any album, that is, erasing the image data file 311 whose file name is contained in the album list 402 of the album list file 401 stored on the memory card 17. If it is determined that the erase directive has been obtained (YES as a determination result), control is passed to S319. If it is determined that the erase directive has not been obtained (NO as a determination result), control is passed to S310.

The contents of the process from S319 to S321 are the same as those shown in FIG. 11B. In this process, all image data files 311 stored on the memory card 17 are erased regardless of whether or not an image are registered in an album.

The process from S310 to S315, that is, the process of erasing only the storage of the image data file 311 of the images not registered in an album, is basically the same as the process shown in FIG. 11B, but in S313, it is not necessary in S313a shown in FIG. 13 to operate a flag indicating that the image data file 311 of at least one frame has been erased.

By the CPU 21 performing the process shown in FIG. 13, the storage of the image data file 311 can be collectively erased without determining (without performing the determining process in S312) whether or not an image has been registered in an album when both storage of the image data file 311 of images not registered in an album and storage of the image data file 311 of images registered in an album are collectively erased. Therefore, the amount of process of the CPU 21 can be reduced, thereby shortening the time required to collectively erase images on the camera 10.

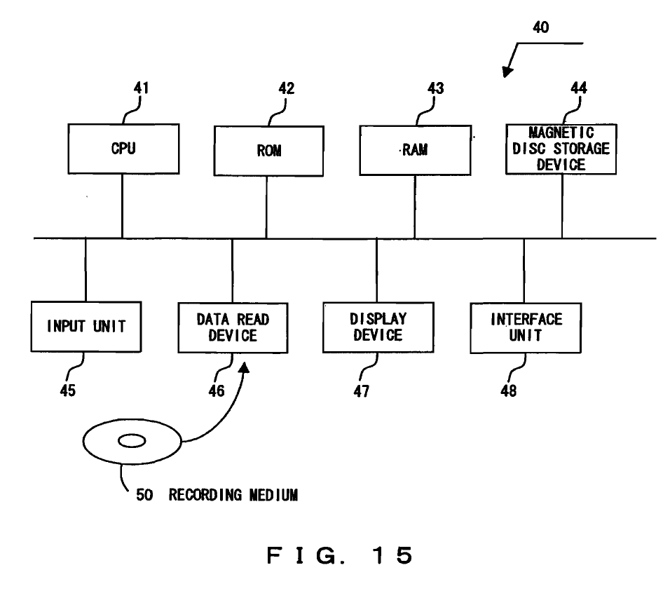

In the process shown in FIGS. 11A and 11B, when images registered in an album are collectively erased, the images registered in any album stored on the memory card 17 have also been collectively erased. Only the images registered in a specified album can also be erased. To attain this, the contents of the process from S319 to S321 in the processes shown in the flowchart in FIG. 11B are to be changed as shown in FIG. 14.

Explained below is the process shown in FIG. 14. In the determining process in S318 shown in FIG. 11B, if it is determined that a directive to erase an image registered in any album has been obtained (YES as a determination result), the screen for allowing a user to select an album whose registered images are to be erased from the list of albums stored on the memory card 17 is displayed on the display unit 19, and a directive of a user to select an album is obtained in S331. FIG. 12G shows an example of the screen.

In FIG. 12G, the numbers from 1 to 6 are assigned to each illustration of the spine of a book (album). The display shows the candidate for the album in which images are to be registered can be six albums from “ALBUM 1” to “ALBUM 6”. In FIG. 12G, the number “1” is enclosed by a rectangle. This indicates that “ALBUM 1” has been selected as an album whose registered images are to be erased.

The switch of selecting an album whose images are to be erased is performed by user operating the cross buttons 23-3, 23-4, 23-5, and 23-6. When the user presses the determination button 23-2, the album selected at this time is determined as an album whose registered images are to be erased, and the CPU 21 obtains the album as a target of the directive of the user to erase the registered images for each album.

A plurality of albums can be selected as those whose images are to be erased.

In S332, a screen for requesting a directive to perform the process of collectively erasing images registered in a selected album or a directive to stop the performance of the process is displayed on the display unit 19.

FIG. 12H shows an example of the screen (process performance directive screen). The CPU 21 displays the screen on the display unit 19 when the pressing operation on the determination button 23-2 of the operation input unit 23 is detected while the above-mentioned calendar display screen is being displayed. The user further operates the operation input unit 23, and selects “OK” or “stop” of the process.

In S333, it is determined whether or not the selection of the user is “OK” for the process. If “OK” of the process is selected (YES as a determination result), control is passed to S334. If “stop” is selected (NO as a determination result), the process from FIG. 11A to FIG. 14 terminates.

In S334, the process performing screen as illustrated in FIG. 12D indicating that a predetermined process is being performed is displayed on the display unit 19.

In S335, in the storage of the image data file 311 on the memory card 17, all files having the file names stored in the album list file 401 of the album list 402 of the albums selected in the process in S331 are all erased, and the album list file 401 is also erased.

In S336, the display of the process performing screen on the display unit 19 is terminated in the S333, and then the process shown in FIG. 11A to FIG. 14 is terminated.

By the CPU 21 performing the above-mentioned process shown in FIG. 14, the camera 10 can collectively erase only the images registered in the album specified by a user.

In the embodiments explained above, the present invention is embodied by the camera 10, but a computer having a standard configuration, that is, as represented by the configuration shown in FIG. 15, a computer 40 formed by a CPU 41 for control of the entire operation of the computer 40, ROM 42 storing a basic control program executed by the CPU 41 and various data used as necessary when the program is executed, RAM 43 used as a work area as necessary when the CPU 41 performs various processes, a magnetic disc storage device 44 storing various control programs executed by the CPU 41, various data used as necessary when the programs are executed, and image data files, an input unit 45 configured by, for example, a pointing device such as a mouse, etc. and a keyboard device, etc. and obtaining an instruction from a user corresponding to the contents of an operation performed using them, a data read device 46 for reading various data recorded on a recording medium 50 such as a CD (compact disc), an MO (magneto optical) disk, a DVD (digital versatile disc), etc., a display device 47 for displaying a predetermined image at an instruction of the CPU 41, an interface unit 48 for communicating various data with other equipment units, etc. can also realize the present invention.

To embody the present invention using the above-mentioned computer 40, for example, a control program used by the CPU 41 of the computer 40 to perform various control processes performed by the CPU 21 of the camera 10 is generated and recorded on the above-mentioned recording medium, and the control program can be read by the computer and executed by the CPU 41.

The recording medium 50 can be a storage device of a computer system and can function as a program server connected to a communicating circuit such as the Internet, etc. In this case, the transmission signal obtained by modulating a carrier wave using a data signal representing the above-mentioned control program is transmitted from a program server to the computer 40 through the communication circuit which is a transmission medium. The computer 40 receives the transmission signal, demodulates it, and regenerates the original control program, thereby executing the control program by the CPU 41.

In addition, the present invention can also be embodied by a PDA (personal digital assistant), a mobile telephone, etc.

Furthermore, the present invention is not limited to the above-mentioned embodiments, but can be improved and modified within the gist of the present invention.

What is claimed is:

1. An apparatus which manages image data, comprising:
a first erase directive obtaining unit obtaining a first directive to erase storage of all image data files stored on a storage medium;
a directive request unit requesting a directive whether or not an image data file indicating possibility of erasing an image belonging to one of groups formed by a plurality of images in the image data files;
a second erase directive obtaining unit obtaining a second directive indicating possibility of erasing an image data file showing an image belonging to any of the groups; and
an erase unit erasing all storage indicating images belonging to any of the groups in storage of the image data file in the storage medium when the second directive obtained after obtaining the first directive permits erasing.

2. The apparatus according to claim 1, wherein
the directive request unit requests a directive to erase or not to erase storage when there is no storage of an image data file representing an image not belonging to any of the groups in the storage medium.

3. The apparatus according to claim 1, further comprising
a non-grouped image data file erase unit erasing only storage of data representing an image not belonging to any of the groups in storage of an image data file in the storage medium when the first directive is obtained, wherein
the directive request unit requests a directive to erase or not to erase a file when there is no storage of an image data file to be erased by the non-grouped image data file erase unit in the storage medium.

4. The apparatus according to claim 1, wherein
the erase unit erases storage of all image data files in the storage medium when the second directive permits erase.

5. The apparatus according to claim 1, wherein
the second erase directive obtaining unit obtains the second directive for each group; and
the erase unit erases only storage of data representing an image belonging to a group specified by the second directive as erase permitted.

6. A method for managing image data, comprising:
obtaining a first directive to erase storage of all image data files stored on a storage medium;
requesting a directive whether or not an image data file indicating possibility of erasing an image belonging to one of groups formed by a plurality of images in the image data files;
obtaining a second directive indicating possibility of erasing an image data file showing an image belonging to any of the groups; and
erasing all storage indicating images belonging to any of the groups in storage of the image data file in the storage medium when the second directive obtained after obtaining the first directive permits erasing.

7. A recording medium which stores a program used to direct a computer to manage image data and from which the program can be read by the computer, the program directs the computer to perform the processes comprising:
obtaining a first directive to erase storage of all image data files stored on a storage medium;
requesting a directive whether or not an image data file indicating possibility of erasing an image belonging to one of groups formed by a plurality of images in the image data files;
obtaining a second directive indicating possibility of erasing an image data file showing an image belonging to any of the groups; and
erasing all storage indicating images belonging to any of the groups in storage of the image data file in the storage medium when the second directive obtained after obtaining the first directive permits erasing.
